(19) United States
(12) Patent Application Publication
(10) Pub. No.: US 2025/0181116 A1
(43) Pub. Date: Jun. 5, 2025

(54) ELECTRONIC DEVICE

(71) Applicant: Lenovo (Beijing) Limited, Beijing (CN)

(72) Inventors: Shaoqing WU, Beijing (CN); Sai GAO, Beijing (CN)

(21) Appl. No.: 18/949,586

(22) Filed: Nov. 15, 2024

(30) Foreign Application Priority Data
Nov. 30, 2023 (CN) 202311632540.7

(51) Int. Cl. G06F 1/16

(52) U.S. Cl. CPC G06F 1/1652

(57) ABSTRACT

An electronic device includes a first body, a second body, a third body, a display assembly, and a target member. The second body is connected to the first body via a first connection apparatus. The first connection apparatus provides a first damping force for a rotation of the first body relative to the second body. The third body is connected to the second body via a second connection apparatus. The second connection apparatus provides a second damping force for a rotation of the third body relative to the second body. The display assembly is connected to the second body and the third body. The target member has a first state and a second state different from the first state.

### CROSS REFERENCE TO RELATED APPLICATION

The present disclosure claims priority to Chinese Patent Application No. 202311632540.7, filed on Nov. 30, 2023, the entire content of which is incorporated herein by reference.

### TECHNICAL FIELD

The present disclosure is related to the electronic device technical field and, more particularly, to an electronic device.

### BACKGROUND

To meet various user requirements for application forms of an electronic device, a designer expects to switch attitudes of the electronic device by changing the form of the electronic device. However, for the electronic device that use a table surface in its main use scenarios, such as a laptop, how to stably place the electronic device on the table in different attitudes without tipping is a technical problem that needs to be solved.

### SUMMARY

An aspect of the present disclosure provides an electronic device including a first body, a second body, a third body, a display assembly, and a target member. The second body is connected to the first body via a first connection apparatus. The first connection apparatus provides a first damping force for a rotation of the first body relative to the second body. The third body is connected to the second body via a second connection apparatus. The second connection apparatus provides a second damping force for a rotation of the third body relative to the second body. The display assembly is connected to the second body and the third body. The target member has a first state and a second state different from the first state. In response to the electronic device being in a first device attitude, the third body relative to a plane formed by the first body and the second body satisfies a target angle, and the target member is in a first state. In response to the electronic device being in a second device attitude, a plane formed by the third body and the second body relative to the first body satisfies the target angle, and the target member is in a second state and is configured to be used to support the second device attitude.

### BRIEF DESCRIPTION OF THE DRAWINGS

FIG. 1 illustrates a schematic diagram of an electronic device according to some embodiments of the present disclosure.

FIG. 2 illustrates a schematic diagram of an electronic device in an unstably placed state according to some embodiments of the present disclosure.

FIG. 3 illustrates a schematic diagram of an electronic device in a stably placed state according to some embodiments of the present disclosure.

FIG. 4 illustrates a schematic diagram of the stably placed state in FIG. 3 from another view angle.

FIG. 5 illustrates a schematic local enlargement diagram of the structure in FIG. 4.

FIG. 6 illustrates a schematic diagram showing a target member of FIG. 5 being taken back into a first body.

FIG. 7 illustrates a schematic diagram showing the target member of FIG. 5 extending out of the first body at a largest degree.

FIG. 8 illustrates a schematic exploded diagram of a first body of an electronic device according to some embodiments of the present disclosure.

FIG. 9 illustrates a schematic diagram showing a state of a protrusion at a shaft facing a sensor according to some embodiments of the present disclosure.

FIG. 10 illustrates a schematic diagram showing a state of a protrusion at a shaft being staggered with a sensor according to some embodiments of the present disclosure.

FIG. 11 illustrates a schematic diagram of another electronic device according to some embodiments of the present disclosure.

FIG. 12 illustrates a schematic diagram of a structure of the target member of FIG. 11.

FIG. 13 illustrates a schematic diagram of another structure of the target member of FIG. 11.

### REFERENCE NUMERALS

| | | |
|---|---|---|
| 1 First body | 11 Sliding groove | 12 Sliding rail |
| 2 Second body | 3 Third body | 4 Display assembly |
| 5 Target member | 51 First support member | 511 First position limiting pillar |
| 512 Second position limiting pillar | | 52 Second support member |
| 521 Second snap structure | | 6 Screw |
| 7 Motor | 71 Sensor | 8 Shaft |
| 81 Protrusion | 9 Keyboard assembly | 101 Unlock switch operation member |
| 1011 Long hole | 102 First snap structure | 103 Linkage rod |
| 200 First elastic member | | 300 Second elastic member |

### DETAILED DESCRIPTION OF THE EMBODIMENTS

The present disclosure provides an electronic device. The electronic device can be stably placed on a desktop surface by satisfying various user requirements for the application forms of the electronic device, preventing the device from easily tipping during use on the desktop surface.

The technical solutions of embodiments of the present disclosure are described in detail in connection with the accompanying drawings of embodiments of the present disclosure. Apparently, the described embodiments are some embodiments of the present disclosure not all embodiments. Based on embodiments of the present disclosure, all other embodiments obtained by those skill in the art without creative efforts are within the scope of the present disclosure.

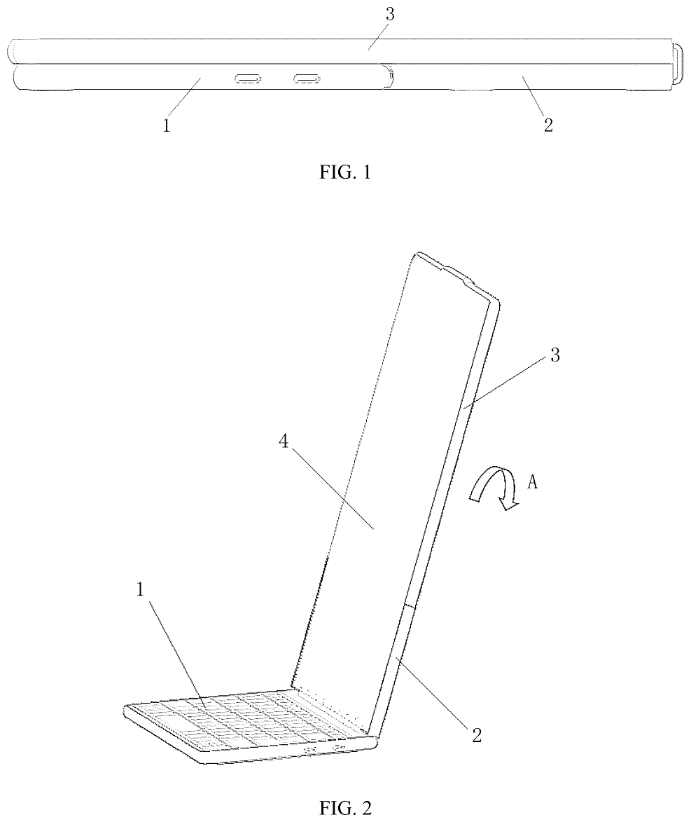

As shown in FIGS. 1 to 10, embodiments of the present disclosure provide an electronic device. The electronic device can include a laptop, a tablet, or a cell phone. For example, the electronic device is described below as a laptop. The electronic device includes a first body 1, a second body 2, a third body 3, a display assembly 4, and a target member 5. The first body 1 and the third body 3 are connected to the second body through a first connection apparatus and a second connection apparatus. That is, the first body 1 and the second body 2 are connected through the first connection apparatus, while the third body 3 and the second body 2 are connected through the second connection apparatus. The first connection apparatus can provide a first damping force for the rotation of the first body 1 relative to the second body 2, and the second connection apparatus can provide a second damping force for the rotation of the third body 3 relative to the second body 2. The first damping force can be used to ensure the first body 1 and the second body 2 to maintain the rotation until the first body 1 and the second body 2 are in an opposite position relationship. The display assembly 4 can be connected to the second body 2 and the third body 3. That is, the first part of the display assembly 4 can be connected to the second body, and a second part of the display assembly 4 can be connected to the third body 3. When the second body 2 rotates relative to the third body 3, the first part of the display assembly 4 can rotate relative to the second part of the display assembly 4. The target member 5 can include a first state and a second state different from the first state. That is, the target member 5 can change states. The target member 5 can be configured to support the electronic device to place the electronic device stably on a carrier surface such as a desk surface under various attitudes.

Since the first connection apparatus provides the first damping force for the rotation of the first body 1 relative to the second body 2, and the second connection apparatus provides a second damping force for the rotation of the third body 3 relative to the second body 2, the electronic device can have various device attitudes. The first connection apparatus and the second connection apparatus can be elastic piece damping shaft assemblies. An axial pressing force can be provided by an elastic piece sleeved at the shaft to a damping piece sleeved at the shaft to generate the damping force for the connected object. When the electronic device is in a first device attitude, the third body can satisfy a target angle relative to the plane formed by the first body 1 and the second body 2, and the target member 5 can be in a first state. That is, in the first device attitude, the first body 1 and the second body 2 can be in a flat state. The third body 3 can have a certain angle relative to the first body 1 and the second body 2 for the user to use the electronic device. For example, the user can use the electronic device on the desktop surface in a normal laptop mode shown in FIG. 9. The first body 1 and the second body 2 are unfolded in a flat state and placed on the desktop surface to support the whole electronic device together. Then, the electronic device and the normal laptop may not tip. Thus, the target member 5 may not need to provide additional support. The target member 5 can be in a state in which the target member 5 does not support the electronic device.

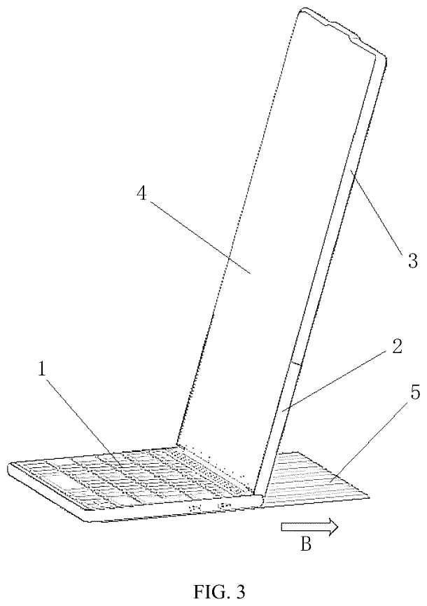

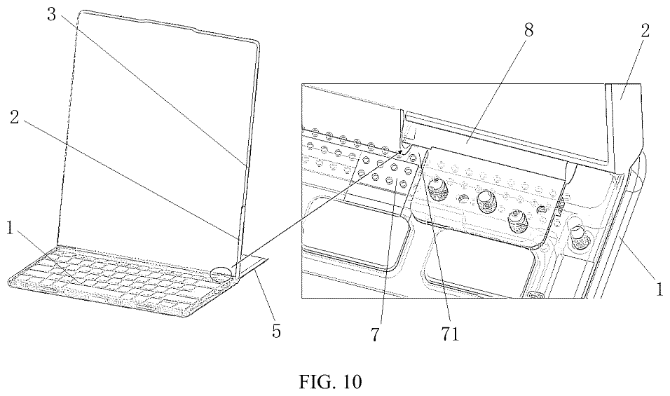

When the electronic device is in the second device attitude, the plane formed by the third body 3 and the second body 2 can satisfy the target angle relative to the first body 1, and the target member 5 can be in a second state and can be configured to support the second device attitude. That is, in the second device attitude, the third body 3 and the second body 2 can be in the flat state. The second body 2 and the first body 1 can have a certain angle for the user to use the electronic device. For example, the user uses the electronic device in a vertical mode shown in FIG. 10. Then, if the first body 1 that is placed on the desktop surface supports the whole electronic device independently, as shown in FIG. 2, the electronic device easily topples along the direction of arrow A. Thus, the target member 5 may need to provide additional support. That is, as shown in FIG. 3 and FIG. 10, the target member 5 is in a state of providing support to the electronic device to support the whole electronic device with the first body 1.

In some embodiments, when the electronic device is in the first device attitude, the target angle can be an angle formed by the display area of the display assembly 4. When the electronic device is in the second device attitude, the target angle can be an angle between the display area of the display assembly 4 and a surface of the first body 1 used for inputting. That is, the first body 1 can include an input assembly, such as a keyboard assembly 9. The surface of the first body 1 used for inputting can be the surface where the input assembly is. The display assembly 4 can include a flexible display screen. The flexible display screen can be supported by the second body 2 and the third body 3 together. Thus, in the first device attitude, the expansion angle between the second body 2 and the third body 3 can be the angle formed by the display area of the display assembly 4, or a folding angle of the flexible display screen. In the second device attitude, the third body 3 and the second body 2 can be in the flat state. Thus, the flexible display screen is not folded. The expansion angle between the second body 2 and the first body 1 can be the angle formed by the display area of the display assembly 4 and the surface of the first body 1 used for inputting, or the angle formed by the flexible display screen and the input assembly.

In the present disclosure, the range of the rotation angle of the second body 2 relative to the first body 1 and the range of the rotation angle of the third body 3 relative to the second body 2 are not limited. For example, the first body 1 and the second body 2 can be configured to rotate relatively more than 180°, 180° at most, or smaller than 180°. The third body 3 and the second body 2 can be set to be able to rotate more than 180°, 180° at most, or smaller than 180°. In some other embodiments, the display area of the display assembly 4 can only be supported by the second body 2 or the third body 3. For example, the display assembly 4 can include a display arranged at the third body 3 and a graphics card arranged at the second body 2. That is, the display area of the display assembly 4 can be only arranged at the third body 3. Then, the second body 2 can include other members such as a speaker. Exemplarily, the output surface of the speaker can be arranged on a surface of the second body 2. Thus, in the first device attitude, the target angle can be the angle formed by the display area of the display assembly 4 and the output surface of the speaker. In the second device attitude, the target angle can be the angle formed by the output surface of the speaker and the surface of the first body 1 used for input.

In some embodiments, when the electronic device is in the first device attitude, a first target area can be formed by the contact position between the first body 1 and the carrier surface and the contact position between the second body 2 and the carrier surface. When the electronic device is in the second device attitude, the second target area can be formed by the contact position between the target member 5 and the carrier surface and the contact position between the first body 1 and the carrier surface. The target area formed by the contact position between the electronic device and the carrier surface can be the support area of the carrier surface. Thus, the condition of placing the electronic device stably on the carrier surface can include that the line of the center of gravity of the electronic device is inside the boundary of the support area. When the electronic device and the carrier surface have more than two contact positions that is discretely distributed. The support area can include the area of the carrier surface corresponding to the contact position and the area of the carrier surface between the contact positions. That is, the area of the support area can be greater than the sum of the areas of the contact positions. In some embodiments, in the first device attitude, the first target area can be formed by the contact position between the first body 1 and the carrier surface and the contact position between the second body 2 and the carrier surface. The contact position of the first body 1 and the carrier surface can be the contact surface formed by the whole or a part of the bottom surface of the first body 1, a contact edge formed by the bottom edge of the first body 1, or a contact point formed by the foot pad of the first body 1. The contact position of the second body 2 and the carrier surface can be a contact surface formed by the whole of a part of the bottom surface of the second body 2, a contact edge formed by the bottom edge of the second body 2, or a contact point formed by the foot pad of the second body 2. In the second device attitude, the second target area can be formed by the contact position of the target member 5 in the second state and the carrier surface and the contact position of the first body 1 and the carrier surface. The contact position of the target member 5 and the carrier surface can be a contact surface formed by the whole or a part of the bottom surface of the target member 5, a contact edge formed by the bottom edge of the target member 5, or a contact point formed by the foot pad of the target member 5. The contact position of the first body 1 and the carrier surface can be a contact surface formed by the whole or a part of the first body 1 and the bottom surface, a contact edge formed by the bottom edge of the first body 1, or a contact point formed by the foot pad of the first body 1. In some embodiments, when the target member 5 is in the first state, the target member 5 may not contact the carrier surface. When the target member 5 is in the second state, the target member 5 can contact the carrier surface. Since the target member 5 in the first state does not contact the carrier surface, when the electronic device is in the first device attitude, the collision or friction of the target member 5 can be avoided to increase the service life of the target member 5.

The states of the target member 5 can be switched manually or automatically. In some embodiments, when the electronic device is in the second device attitude, and the satisfied target angle of the plane formed by the third body 3 and the second body 2 relative to the first body 1 is larger, the second target area can be larger. As shown in FIG. 3, in the second device attitude, when the satisfied target angle of the plane formed by the third body 3 and the second body 2 relative to the first body 1 is larger, the third body 3 and the second body 2 can further rotate in a direction away from the first body 1. Thus, the center of gravity of the whole electronic device can move in the direction away from the first body 1, i.e., the direction of arrow B in FIG. 3. Thus, if the second target area is unchanged, the electronic device can easily topple. The second target area can be formed by the contact position of the target member in the second state and the carrier surface and the contact position of the first body 1 and the carrier surface. When the second target area is larger, the contact position of the target member 5 and the carrier surface moves or expands along the direction of arrow B in FIG. 3. Thus, the electronic device can be prevented from toppling in the second device attitude. The target member 5 can switch states automatically. The action of the target member 5 can be linked to the relative rotation action of the second body 2 and the first body 1. As the expansion angle between the second body 2 and the first body 1 is increased, the contact position of the target member 5 and the carrier surface can expand, close, or move toward the direction away from the first body 1 to enlarge the area of the support area. In some embodiments, the linkage movement can be realized through a pure mechanical method or a combination of the mechanical and electrical methods. For example, the rotation shaft of the first connection apparatus can be connected to the target member 5 through a transmission mechanism. Thus, the movement of the rotation shaft can drive the target member 5 to move to cause the state of the target member 5 to change, or the a sensor element capable of detecting the movement of the rotation shaft can be arranged at the first connection apparatus, and the sensor element can be electrically connected to the electrical apparatus that is configured to drive the target member 5 to move.

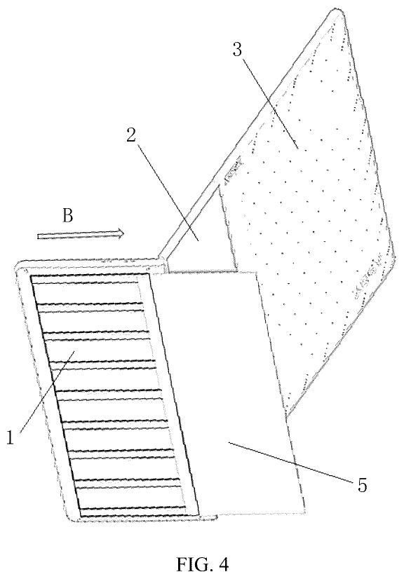

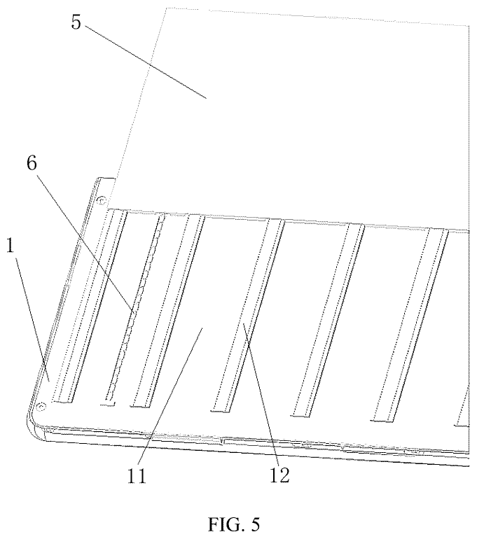

In some embodiments, the target member 5 can be movably connected to the first body 1. When the target member 5 is in the first state, the target member 5 can be located in the first body 1. When the target member is in the second state, the target member 5 can be at least partially located outside the first body 1. That is, the first body 1 can include an accommodation space for accommodating the target member 5. The target member 5 can move relative to the first body 1 to change states. When the target member 5 is in the first state, the target member 5 can be within the accommodation space. When the target member 5 is in the second state, at least a part of the target member 5 can be located outside the accommodation space. The target member 5 can move relative to the first body 1 in various manners, such as moving or rotating. As shown in FIGS. 3 and 4, in some embodiments, the target member 5 is telescopically connected to the first body 1 and extends in the direction of arrow B of FIG. 5.

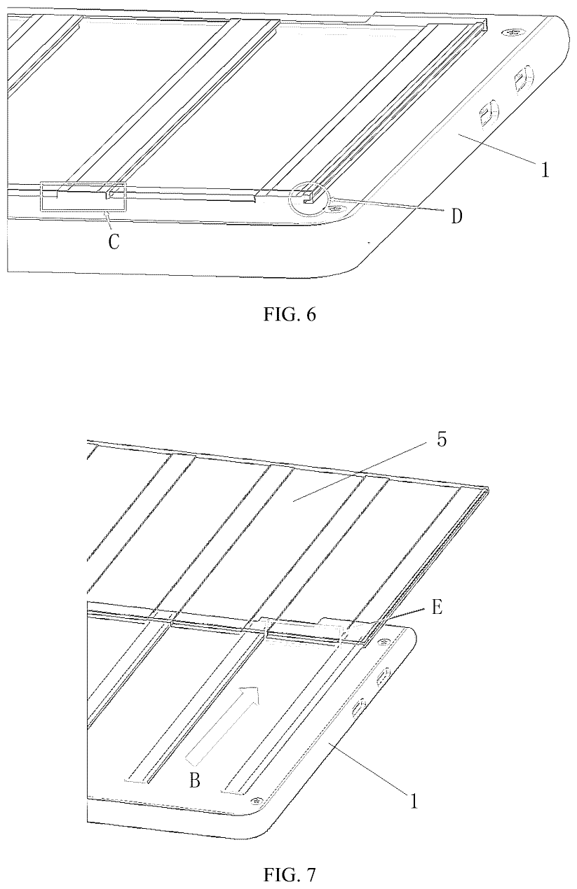

As shown in FIGS. 5 to 7, to ensure the target member 5 to smoothly and stably move relative to the first body 1, a plurality of parallel rails 12 are provided. A sliding groove 11 is formed between neighboring sliding rails 12. The extension direction of the sliding rails 12 are the moving direction of the target member 5 relative to the first body 1. As shown in position E of FIG. 7, the target member 5 includes a position limiting structure located in the sliding groove 11. When the target member 5 moves along the sliding rail 12 to an extreme position, the position limiting structure is snapped by edges of the sliding groove 11 to prevent the target member 5 from continuing to move forward. As shown in position C of FIG. 6, the side surface of the sliding rail 12 abuts against the position limiting structure of the target member 5 in the sliding groove 11 to avoid vibration of the target member 5 during moving. As shown in position D of FIG. 6, the sliding rail 12 at the side includes a raised rib on an outer side of the sliding rail 12. The target member 5 includes a hook cooperating with the raised rib to limit the movement of the target member 5 relative to the first body 1 in the thickness direction.

In some embodiments, the target member 5 can take various structural forms. For example, the target member 5 has a plate-structure as shown in FIG. 3 and FIG. 4. The target member 5 can have a frame structure composed by rods. In some embodiments, the target member 5 can include support rods on two sides of the first body 1. The support rod can be configured to move along the direction parallel to the side edge of the first body 1. Thus, the target member 5 can form the second target area with the first body 1. The support rods can be also configured to rotate relative to the side edge of the first body 1 by more than 90°, e.g., 100°, 150°, or 180°, to reach the outer side of the first body 1 along the direction of arrow B in FIG. 3. Thus, the target member 5 can form the second target area with the first body 1.

In some embodiments, the length of the target member 5 extending out from the first body 1 can be linked to the target angle in the second device attitude. That is, when the expansion angle between the second body 2 and the first body 1 changes in the second device attitude, the target member 5 can automatically move relative to the first body 1 to change the length extending out from the first body 1, which prevents the user from manually operating the target member 5. Thus, the electronic device can be used more conveniently. When the target member 5 can automatically move relative to the first body 1, the length of the target member 5 extending out from the first body 1 can be set to a fixed value in the second device attitude.

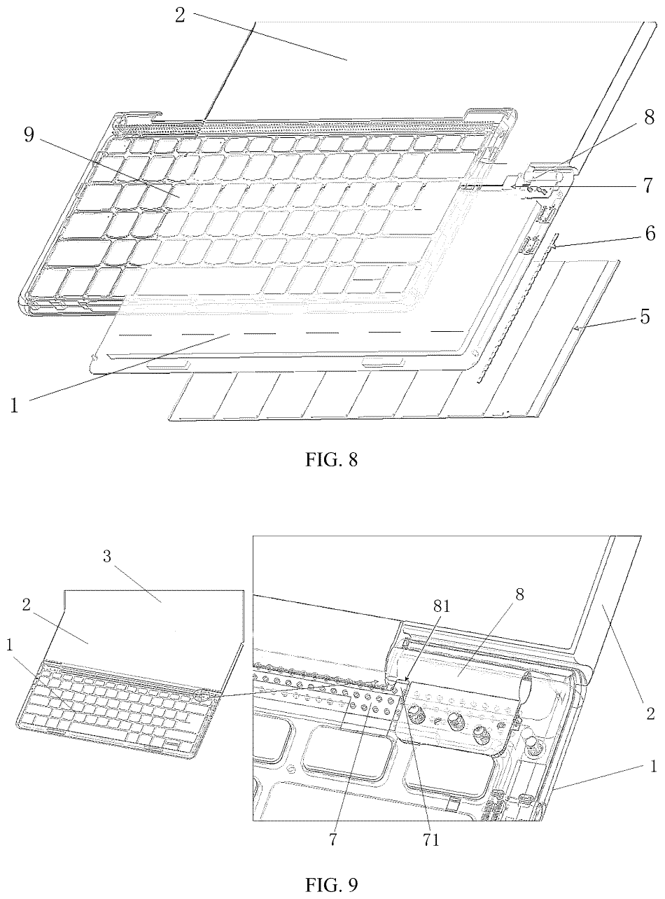

As shown in FIG. 5, and FIG. 8 to FIG. 10, in some embodiments, the first body 1 includes a motor 7 and a screw 6 configured to drive the target member 5. A sensor 71 electrically connected to the motor 7 is arranged at a position close to the second body 2. A sensing object of the sensor 71 is provided at the rotation shaft 8 of the first connection apparatus at the rotation shaft 8, i.e., a protrusion 81 at the rotation shaft 8. The screw 6 can be threadedly connected to the target member 5. When the motor 7 drives the screw 6 to rotate, the target member 5 can move relative to the first body 1. As shown in FIG. 9, when the electronic device is in the first device attitude, the protrusion 81 of the rotation shaft 8 faces the sensor 71. When the second body 2 rotates relative to the first body 1, the rotation shaft 8 rotates with the second body 2. After rotating for a certain angle, the protrusion 81 can be staggered with the sensor 71. Then, the motor 7 can be started to rotate the screw 6. After the target member 5 extends out from the first body 1 to the extreme position, the motor 7 may stop. Subsequently, when the second body 2 continues to rotate toward the first body 1, the length of the target member 5 extending out from the first body 1 can be unchanged or decrease with the rotation of the second body 2. In some embodiments, a Hall element can be used to detect the continuous rotation of the second body 2 toward the first body 1. When the motor 7 rotates reversely, the target member 5 can move into the first body 1. Thus, the length of the target member 5 extending out from the first body 1 can decrease.

In some embodiments, the target member 5 can be configured to be pulled by hands to perform an operation. For example, when the user uses the electronic device as the normal laptop shown on the left side of FIG. 9, the target member 5 can be pushed into the first body 1 to hide the target member 5. When the user uses the electronic device in the vertical mode shown on the left side of FIG. 10, the target member 5 can be pulled out from the first body 1. Thus, the target member 5 can form the second target area with the first body 1 to support the second device attitude of the electronic device. In the second device attitude, if the plane formed by the third body 3 and the second body 2 have a relatively small angle relative to the first body 1, e.g., 95° to 110°, only a part of the target member 5 can be pulled out. When the plane formed by the third body 3 and the second body 2 has a relatively large angle relative to the first body 1, e.g., 120° to 150°, the target member 5 can be continued to be pulled out to increase the length of the target member 5 extending out of the first body 1. Otherwise, when the third body 3 and the second body 2 rotate to the direction of the first body 1, the angle of the plane formed by the third body 3 and the second body 2 relative to the first body 1 can be gradually decreased. Then, the target member 5 can be pushed back to the first body 1 to reduce the length of the target member 5 extending out of the first body 1.

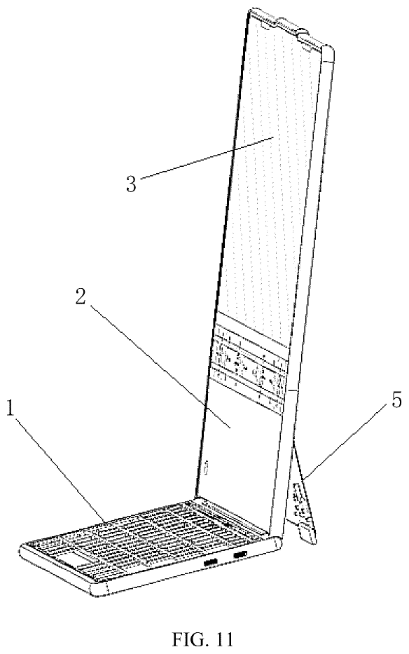

As shown in FIGS. 11 to 13, in the electronic device of embodiments of the present disclosure, the target member 5 is connected to the second body 2. When the target member 5 is in the first state, the target member 5 can be in contact with the second body 2. When the target member 5 is in the second state, the target member 5 can be expanded relative to the second body 2. FIG. 11 illustrates the expanded state of the target member 5 relative to the second body 2. Then, the target member 5 and the second body 2 form a V-shaped support structure. The upper end of the target member 5 can be rotatably connected to the second body 2. Thus, the target member 5 can rotate to the position to be in contact with the second body 2. That is, the side of the target member at the lower end position close to the second body 2 can contact the surface of the second body 2. In some embodiments, the target member 5 can be closed and connected to the second body 2. That is, the surface of the second body 2 can have a groove structure configured to accommodate the target member 5. When the target member 5 is in the first state, the target member 5 can be retracted back into the groove structure. Thus, the outer surface of the target member 5 can be flush with the surface of the second body 2.

In some embodiments, the expanded angle between the target member 5 and the second body 2 can be linked with the target angle of the second device attitude. That is, when the expanded angle of the second body 2 and the first body 1 in the second device attitude changes, the target member 5 can automatically rotate relative to the second body 2 to change the expanded angle between the target member 5 and the second body 2. Thus, the user can be prevented from manually operating the target member 5, and the electronic device can be used more conveniently.

Based on the connection between the target member 5 and the second body 2, the target member 5 can have various structural forms. In some embodiments, the target member 5 can include a first support member 51 hinged to the second body 2 and a second support member 52 movably connected to the first support member 51. The target member 5 can adjust the length of the target member 5 in the support direction based on the relative movement between the first support member 51 and the second support member 52. As shown in FIG. 11, when the expanded angle between the target member 5 and the second body 2 is fixed, the second body 2 and the third body 3 can be straighter by increasing the length of the target member 5, and the expanded angle of the second body 2 and the third body 3 relative to the first body 1 can be larger by decreasing the length of the target member 5. Thus, when the second body 2 and the third body 3 are expanded to a plurality of different angles relative to the first body 1, the target member 5 can well adapt and provide a reliable support.

In some embodiments, the first support body 51 can be slidingly connected to the second support body 52. That is, the target member 5 can have a telescopic structure. In some embodiments, the target member 5 can include an unlocking switch movably connected to the first support member 51. The unlocking switch can include a first snap structure 102. The target member 5 can further include a first elastic member 200 connected between the first snap structure 102 and the second snap structure 521. When the target member 5 is in the retracted state, the second snap structure of the second support member 52 can be snapped with the first snap structure 102 of the unlocking switch. After the user operates the unlocking switch to release the snap connection, the second support member 52 can slide relative to the first support member 51 under the action of the elastic restore force of the first elastic member 200. Then, the target member 5 can extend longer. In some embodiments, the target member 5 can include a second elastic member 300. The second elastic member 300 can be connected between the first support member 51 and the unlocking switch and configured to reset the unlocking switch. That is, after the user releases the unlocking switch, the unlocking switch can restore to an initial state under the action of the elastic restore force of the second elastic member 300.

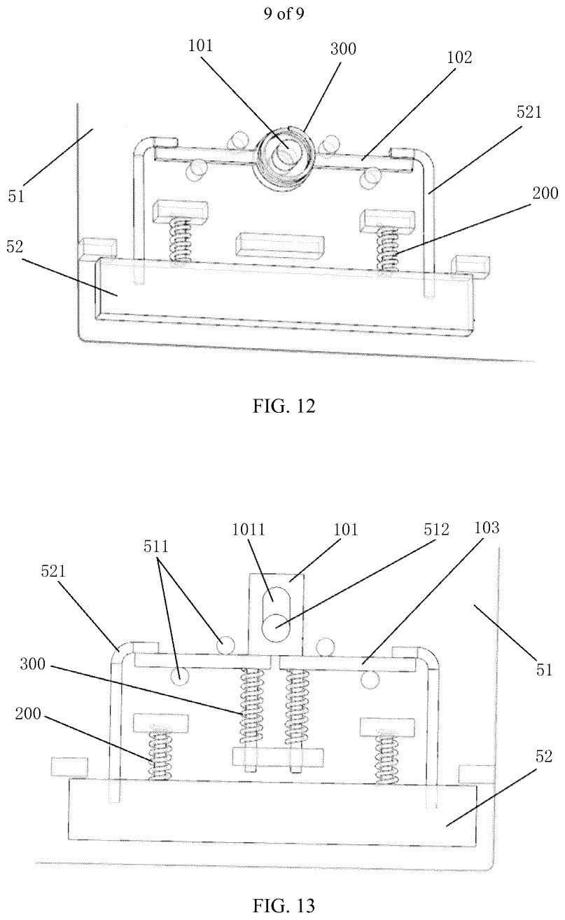

The unlocking switch can have various structures. As shown in FIG. 12, the unlocking switch is a button. That is, the user can press the operation member 101 of the unlocking switch to release the snap connection between the second snap structure 521 and the first snap structure 102. The pressing direction can be perpendicular to the sliding direction of the second support member 52 relative to the first support member 51. As shown in FIG. 13, the unlocking switch is a toggle. That is, the user can pull the operation member 101 of the unlocking switch to release the snap connection between the second snap structure 521 and the first snap structure 102. The pulling direction can be parallel to the sliding direction of the second support member 52 relative to the first support member 51. In some embodiments, the unlocking switch includes a linkage rod 103. The first support member 51 includes two first position limiting pillars 511 arranged on two sides of the linkage rod 103 and staggered with the length direction of the linkage rod 103. An end of the linkage rod 103 can abut against with the operation member 101 of the unlocking switch. The other end of the linkage rod 103 can be configured to be snapped with the second snap structure 521 of the second support member 52. As shown in FIG. 13, the first support member 51 includes a second position limiting pillar 512. The operation member 101 of the unlocking switch can include a long hole 1011 slidingly cooperating with the second position limiting pillar 512. When the operation member 101 of the unlocking switch is toggled downward from the state shown in FIG. 13, the linkage rod 103 can rotate using the first position limiting pillar 511 below as a supporting point. The second snap structure 521 can move up for a distance under the action of the linkage rod 103. Then, the second snap structure 521 can be separated from the linkage rod 103. Then, the second support member 52 can move downward relative to the first support member 51 under the action of the first elastic member 200. Otherwise, when the second support member 52 is retracted, after the second snap structure 521 that moves upward is in contact with the linkage rod 103, the linkage rod 103 can first rotate for an angle when being pushed by the second snap structure 521 by using the first position limiting pillar 511 as the supporting point. Then, the linkage rod 103 can be separated from the second snap structure 521, which continues to rise, and the linkage rod 103 returns to the state shown in FIG. 13 under the action of the second elastic member 300. After the force causing the second support member 52 to move up is removed, the second snap structure 521 can return to the position of the linkage rod 103 and can be snapped with the linkage rod 103 under the action of the first elastic member 200.

Various structures of the present disclosure are described in a progressive manner. The description of each part of the structure focuses on the difference from the existing structure. The whole and partial structure of the electronic device can be obtained through a combination of the plurality of parts of structures.

The above description of embodiments of the present disclosure can enable those skilled in the art to implement or use the present disclosure. Various modifications made to embodiments of the present disclosure are apparent to those skilled in the art. The general principle defined in the specification can be implemented in other embodiments without departing from the spirit or scope of the present disclosure. Thus, the present disclosure is not limited to embodiments shown in the specification but conforms to the widest scope consistent with the principles and novel features of the present disclosure.

What is claimed is:

1. An electronic device comprising:
a first body;
a second body connected to the first body via a first connection apparatus, the first connection apparatus providing a first damping force for a rotation of the first body relative to the second body;
a third body connected to the second body via a second connection apparatus, the second connection apparatus providing a second damping force for a rotation of the third body relative to the second body;
a display assembly connected to the second body and the third body; and
a target member having a first state and a second state different from the first state;
wherein:
in response to the electronic device being in a first device attitude, the third body relative to a plane formed by the first body and the second body satisfies a target angle, and the target member is in a first state;
in response to the electronic device being in a second device attitude, a plane formed by the third body and the second body relative to the first body satisfies the target angle, and the target member is in a second state and is configured to be used to support the second device attitude.

2. The electronic device according to claim 1, wherein:
in response to the electronic device being in the second device attitude, the target angle is an angle formed by the display area of the display assembly; and
in response to the electronic device being in the second device attitude, the target angle is an angle formed by the display area of the display assembly with the input surface of the first body.

3. The electronic device to claim 1, wherein:
in response to the electronic device being in the first device attitude, a first target area is formed by a contact position between the first body and a carrier surface and a contact position between the second body and the carrier surface; and
in response the electronic device being in the second device attitude, a second target area is formed by a contact position between the target member in a second state and the carrier surface and a contact position between the first body and the carrier surface.

4. The electronic device according to claim 3, wherein:
in response to the electronic device being in a second device attitude, when the target angle of the plane formed by the third body and the second body relative to the first body is larger, the second target area is larger.

5. The electronic device according to claim 1, wherein:
the target member is movably connected to the first body;
in response to the target member being in a first state, the target member is in the first body; and
in response to the target member being in a second state, the target member is wholly or partially located outside the first body.

6. The electronic device according to claim 5, wherein the target member is telescopically connected to the first body.

7. The electronic device according to claim 5, wherein a length of the target member extending out of the first body is linked with the target angle of the second device attitude.

8. The electronic device according to claim 1, wherein:
the target member is connected to the second body;
in response to the target member being in the first state, the target member contacts the second body; and
in response to the target member being in the second state, the target member expands relative to the second body.

9. The electronic device according to claim 8, wherein the target member and the second body are closed and connected.

10. The electronic device according to claim 8, wherein an expanded angle between the target member and the second body is linked with the target angle of the second device attitude.
